(19) United States
(12) Patent Application Publication
(10) Pub. No.: US 2020/0012101 A1
(43) Pub. Date: Jan. 9, 2020

(54) HEAD-MOUNTED DISPLAY

(71) Applicant: SHARP KABUSHIKI KAISHA, Sakai City, Osaka (JP)

(72) Inventors: RYUZO YUKI, Sakai City, Osaka (JP); TOMOHIRO KIMURA, Sakai City, Osaka (JP); TAKAYUKI NISHIYAMA, Sakai City, Osaka (JP); NARU USUKURA, Sakai City, Osaka (JP); TAKESHI MASUDA, Sakai City, Osaka (JP)

(21) Appl. No.: 16/495,644

(22) PCT Filed: Mar. 26, 2018
(86) PCT No.: PCT/JP2018/012066

§ 371 Date: Sep. 19, 2019

(30) Foreign Application Priority Data
Mar. 31, 2017 (JP) 2017-071775

(51) Int. Cl. G02B 27/01; G02B 27/00

(52) U.S. Cl. CPC G02B 27/0101; G02B 2027/0178; G02B 27/0172; G02B 27/0093

(57) ABSTRACT

The size and weight of an eyepiece are reduced while the diameter of each eyepiece is maintained. In a head-mounted display (1) of the invention of a display region of a display device (102), an area of an image which a user views through the eyepiece (105) is an effective display region, and an area other than the area of the image which the user views is an ineffective display region, each of the display devices (102) has a shape in which the ineffective display region is cut out from the display region.

### TECHNICAL FIELD

The present invention relates to a head-mounted display.

### BACKGROUND ART

In recent years, for a display apparatus such as a TV set, research and development of a technique for enlarging a display region have been actively conducted so that a user can enjoy pictures that are more powerful. For example, a head-mounted display is known which is used by being worn on the head of a user and which is configured to give a sense of intensive immersion to the user (for example, PTL 1).

### CITATION LIST

### Patent Literature

PTL 1: Japanese Patent No. 5824697 (registration date: Oct. 23, 2015)

### SUMMARY OF INVENTION

### Technical Problem

A typical head-mounted display shown in FIGS. 11 to 13, however, has the following problems.

FIG. 11 schematically shows a configuration of a conventional head-mounted display, wherein (a) is a front view, and (b) is a sectional view taken in the direction of arrows X-X of (a).

FIG. 12 schematically shows a configuration of a conventional head-mounted display, wherein (a) is a front view, and (b) is a sectional view taken in the direction of arrows Y-Y of (a).

FIG. 13 schematically shows a configuration of a conventional head-mounted display, wherein (a) is a front view, and (b) is a sectional view taken in the direction of arrows Z-Z of (a).

For example, as illustrated in FIG. 11, when display devices 1102 increase in size, a user can enjoy more powerful pictures, but a housing 1101 and eyepieces 1105 increase in size, which leads to a problem of an increased weight of a product.

Here, the head-mounted display shown in FIG. 11 includes an infrared camera 1103 and infrared light sources 1104 which are provided to the housing 1101 in order to track gaze of the eyes 10 of a user. The infrared light sources 1104 are disposed around each display device 1102 when the head-mounted display is viewed from the front, and therefore, the infrared light sources 1104 increases the size of the housing 1101.

Thus, in a head-mounted display shown in FIG. 12, infrared light sources 1104 are disposed around each eyepiece 1105 to reduce the size of a housing 1101 when the head-mounted display is viewed from the front. However, a control unit 1106 configured to perform display control and the like of the display devices 1102 is provided on a rear surface side of the display devices 1102, and therefore, connection components 1107 each connecting a corresponding one of the infrared light sources 1104 to the control unit 1106 are long and have complicated shapes, causing a problem that cost increases.

Therefore, a head-mounted display shown in FIG. 13 is configured to achieve a reduction in size and weight by downsizing the head-mounted display itself shown in FIG. 11. However, in the head-mounted display, eyepieces 1105 each have a diameter smaller than that of each of the eyepieces 1105 of the head-mounted display shown in FIG. 11. Therefore, a field of view (FOV) is reduced, thereby leading to a new problem, namely, a reduction of realistic sensation.

One aspect of the present invention is directed to an object of realizing a head-mounted display configured to achieve a reduction in size and weight while the diameter of an eyepiece is maintained.

### Solution to Problem

To solve the problem, a head-mounted display according to an aspect of the present invention is a head-mounted display including: a housing; display sections in each of which an image is to be displayed; and eyepieces with which a user views the display sections, the display sections and the eyepieces being provided to the housing, wherein each of the display sections includes a display region in which an area of the image viewed by the user through a corresponding one of the eyepieces is an effective display region and an area other than the area of the image viewed by the user is an ineffective display region, and each of the display sections has a shape in which the ineffective display region is cut out from the display region.

Moreover, a head-mounted display according to an aspect of the present invention is a head-mounted display including: a housing; display sections in each of which an image is to be displayed; and eyepieces with which a user views the display sections, the display sections and the eyepieces being provided to the housing, wherein each of the display sections includes a display region in which an area of the image viewed by the user through a corresponding one of the eyepieces is an effective display region and an area other than the area of the image viewed by the user is an ineffective display region, and in the ineffective display region, a light-receiving element is disposed.

### Advantageous Effects of Invention

An aspect of the present invention enables a reduction in size and weight while the diameter of each eyepiece is maintained.

### BRIEF DESCRIPTION OF DRAWINGS

FIG. 1 is a view schematically illustrating a configuration of a head-mounted display according to a first embodiment of the present invention.

FIG. 2 is a functional block diagram illustrating the head-mounted display shown in FIG. 1.

FIG. 3 is a view schematically illustrating a configuration of a variation of the head-mounted display shown in FIG. 1.

FIG. 4 is a view schematically illustrating a configuration of a head-mounted display according to a second embodiment of the present invention.

FIG. 5 is a view schematically illustrating a configuration of a head-mounted display according to a third embodiment of the present invention.

FIG. 6 is a detailed view illustrating the head-mounted display shown in FIG. 5.

FIG. 7 is a view schematically illustrating a configuration of a comparative example of the head-mounted display shown in FIG. 5.

FIG. 8 is a view illustrating a flow of a process of illumination detection and eye tracking by the head-mounted display shown in FIG. 5.

FIG. 9 is a view illustrating a flow of a process of illumination detection and eye tracking by the head-mounted display of the comparative example.

FIG. 10 is a view schematically illustrating a configuration of the head-mounted display according to the first embodiment of the present invention, wherein (a) is a front view, and (b) is a sectional view taken in the direction of arrows C-C of (a).

FIG. 11 is a view schematically illustrating a configuration of a conventional head-mounted display.

FIG. 12 is a view schematically illustrating a configuration of a conventional head-mounted display.

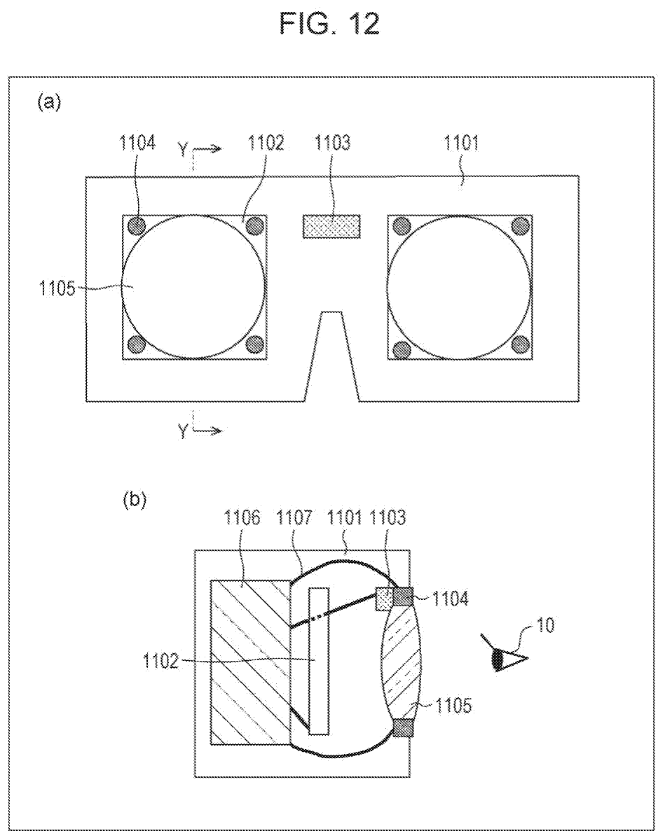

FIG. 13 is a view schematically illustrating a configuration of a conventional head-mounted display.

### DESCRIPTION OF EMBODIMENTS

### First Embodiment

Embodiments of the present invention will be described in detail below.

<Schema of Head-Mounted Display>

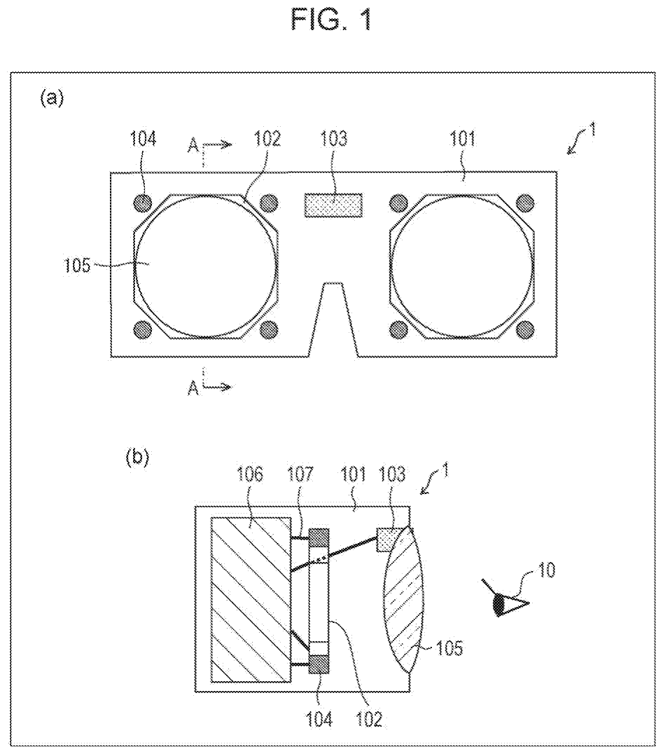

First, based on FIG. 1, a schema of a head-mounted display 1 according to an embodiment of the present invention will be described. FIG. 1 schematically shows a configuration of the head-mounted display 1, wherein (a) is a front view, and (b) is a sectional view taken in the direction of arrows A-A of (a).

The head-mounted display 1 is a display apparatus mountable on the head of a user. The head-mounted display 1 is a binocular and immersive head-mounted display which completely covers the eyes of the user in a state where the head-mounted display is mounted on the head of the user. The same applies to head-mounted displays 1a, 1b, 1c, and 2 to 4 which will be described later.

Specifically, as illustrated in (a) of FIG. 1, the head-mounted display 1 includes two display devices 102 (display sections), an infrared camera 103, a plurality of infrared light sources 104, and two round eyepieces 105 which are in a housing 101. As illustrated in (b) of FIG. 1, the head-mounted display 1 further includes a control unit 106. The control unit 106 is provided to face a rear surface (a surface on an opposite side from a display surface) of the display devices 102. The control unit 106 is configured to control the display devices 102. The display devices 102, the infrared camera 103, and the infrared light sources 101 are electrically connected to the control unit 106 via connection components 107 such as Flexible printed circuits (FPCs). A user wears the head-mounted display 1 such that the eyes 10 of the user face the eyepieces 105, and thereby, the user views images displayed on the display devices 102.

Each display device 102 includes an organic EL display, and as shown in (a) of FIG. 1 and has an octagonal outer shape. That is, each display device 102 has a shape corresponding to an outer shape of a corresponding one of the eyepieces 105. The outer shape of the eyepiece 105 corresponds to a shape formed when the eyepiece 105 is projected onto the display device 102. Each display device 102 has a variant shape (an octagonal shape) and has a narrow frame. Thus, the display devices 102 each having a variant shape and having a narrow frame may be realized, for example, by distributing terminal units for receiving signals on a plurality of locations or by distributing peripheral circuits (gate drivers) in a display region. Note that examples of the display devices 102 may include a liquid crystal display and other display devices in addition to the organic EL display.

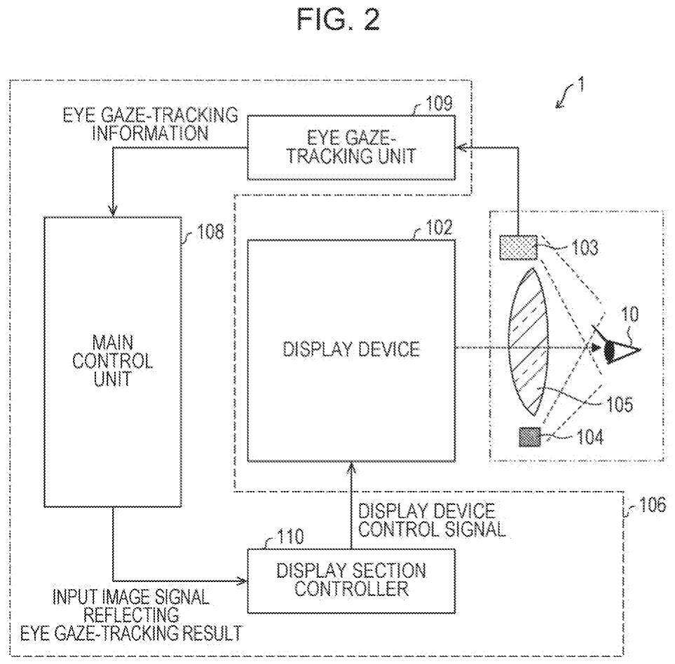

The infrared camera 103 is provided between the two eyepieces 105 and is configured to image the eyes 10 of the user. Based on a picture of the eyes 10 of the user imaged by the infrared camera 103, tracking of the eye gaze of the user is performed. The tracking of the eye gaze is performed by an eye gaze-tracking unit 109 (FIG. 2) which will be described later. The infrared camera 103 is connected to the control unit 106 via a connection component 107, and imaging control is performed by the control unit 106.

The infrared light sources 104 are in proximity to four cut out sections of each display device 102 and are on the same surface as the each display device 102. The infrared light sources 104 are configured to emit infrared light toward the eyes 10 of the user when imaging is performed by the infrared camera 103. The infrared light sources 104 are connected to the control unit 106 via connection components 107 and are controlled by the control unit 106.

The eyepieces 105 are provided on a near side of the housing 101 (to face a user). The eyepieces 105 are configured to enlarge pictures displayed on the display devices 102 and deliver the pictures to the eyes 10 of the user.

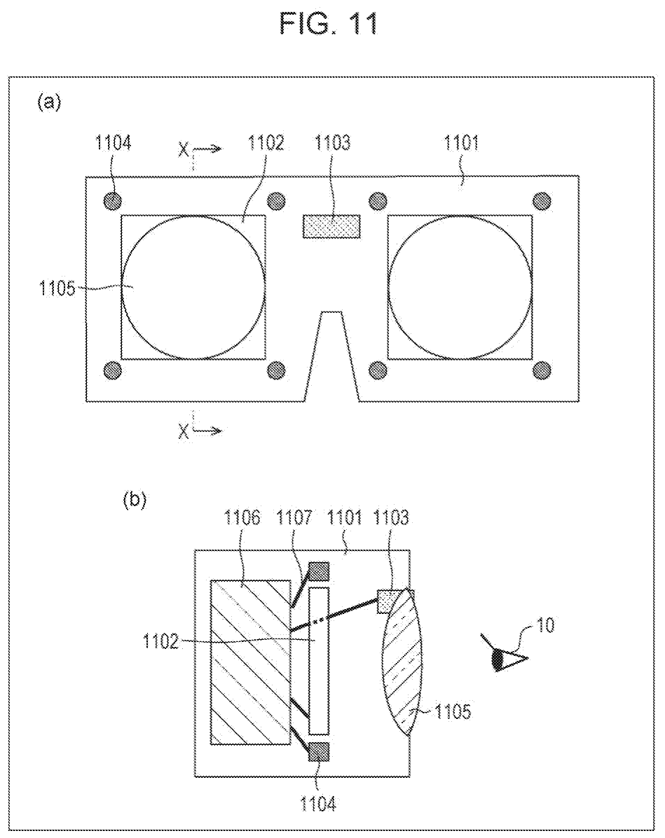

Regions in which the eyepieces 105 is projected onto the display devices 102 are display regions, and the eyepieces 105 are configured to deliver the pictures to the eyes 10 of the user. Thus, in a case where the display devices 102 each have a quadrangular shape as a display device 1102 of a conventional configuration shown in FIG. 11, when the eyepieces 105 each have a round shape, and as illustrated in (a) of FIG. 1, projection regions in which the eyepieces 105 are projected onto the display devices 102 are within the display regions of the display devices 102, four corners of each display device 102 are not recognized as display regions. Portions which are not recognized as the display regions are eliminated from the display devices 102, and in locations from where the portions have been eliminated, the infrared light sources 104 are provided.

Note that the shape of each display device 102, the number and disposition location of the infrared camera 103, the number and disposition locations of the infrared light sources 104, and the shape and size of each eyepiece 105 are not limited to the example described above.

The control unit 106 comprehensively controls the head-mounted display 1. Specifically, the control unit 106 tracks the eye gaze of the user and controls the display devices 102 such that images according to a result of the tracking are displayed. Details of the process will be described below.

<Functional Configuration of Head-Mounted Display>

Next, based on FIG. 2, a functional configuration of the head-mounted display 1 will be described. FIG. 2 is a functional block diagram illustrating the functional configuration of the head-mount display 1.

As illustrated in FIG. 2, the head-mounted display 1 includes a main control unit 108, the eye gaze-tracking unit 109, and a display section controller 110 which are in the control unit 106.

The main control unit 108 generates image data for causing displaying on a display screen of the display device 102. The image data generated is once stored in Video Random Access Memory (VRAM) built in the control unit 106. From the VRAM, the image data is read, and at a prescribed timing, the image data is transferred to the display section controller 110.

The image data is transferred from the VRAM to the display section controller 110, and thereby, the image data is written in the display screen of the display device 102, and an image is displayed on the display screen.

Moreover, the main control unit 108 controls writing operation of the image data to the display devices 102. However, the control of the operation may be performed by the display device 102.

Note that the control unit 106 may be built in the head-mounted display 1 or may be an external device attached to the head-mounted display 1. Alternatively, for example, the control unit 106 may be a network server used via a communication unit (not shown) included in the head-mounted display 1.

Moreover, the main control unit 108 transmits, based on eye gaze-tracking information from the eye gaze-tracking unit 109, an input image signal reflecting the eye gaze-tracking information to the display section controller 110.

The eye gaze-tracking unit 109 is configured to: accurately grasp locations of pupils based on a picture obtained by imaging, with the infrared camera 103, how infrared light emitted from the infrared light sources 104 is reflected off the eyes 10 of the user; and output the locations as the eye gaze-tracking information to the main control unit 108. Specifically, the infrared camera 103 captures a relative distance between cornea reflection (which is a surface reflection at a cornea, and therefore bright spot location do not move and is fixed) of the infrared light and a pupil (which becomes a dark part due to absorption by an iris and moves along the eye gaze direction), and based on the movement of the eyeballs of the user, the eye gaze direction of the user is specified. In this case, each infrared light source 104 is desirably a light source configured to emit infrared light having a wavelength of 800 nm to 2500 nm. Moreover, the infrared camera 103 is desirably a wide-angle camera. Note that the location of the infrared camera 103 is not limited to the location shown in FIG. 1 as long as the infrared camera 103 is located to be able to appropriately image the eyes 10 of a user. For example, the infrared camera 103 may be disposed at a location adjacent to the infrared light source 104.

The display section controller 110 outputs a display device control signal to the display devices 102. The display device control signal is a signal for causing the display devices 102 to display images according to the input image signal reflecting the eye gaze-tracking information transmitted from the main control unit 108. Thus, the display devices 102 display images obtained by tracking the gaze of the user.

Here, the input image signal reflecting the eye gaze-tracking information is a signal accurately showing only an eye gaze region of a user with a picture of the surroundings out of the eye gaze being compressed. In general, in the head-mounted display 1, a time (Motion to Photon) from detection of the movement of a user (the movement of the body such as orientation of the head) to showing of a picture corresponding to the movement to the eyes of the user has to be reduced as much as possible. For example, when the Motion to Photon increases, a user may become sick from Virtual reality (VR). That is, the Motion to Photon has to be reduced as much as possible, that is, the transmission speed of the picture has to be increased as much as possible so that a user do not become sick from the VR. Thus, in order to increase the transmission speed of the picture, picture data to be transmitted has to be reduced in size, and therefore, as described above, the input image signal reflecting the eye gaze-tracking information has to be a signal accurately showing only the eye gaze region of a user with a picture of the surroundings out of the eye gaze being compressed.

<Effects>

In the head-mounted display 1 having the configuration described above, each display device 102 has an outer shape corresponding to the outer shape of a corresponding one of the eyepieces 105. The display region of the display device 102 at least includes a projection region in which the eyepiece 105 is projected onto the display device 102, and the outer periphery of the display device 102 is in the proximity of the outer periphery of the projection region.

This enables only the installation area of each display device 102 provided to the housing 101 to be reduced without changing the size of each eyepiece 105. Thus, it is possible to downsize the housing 101 by a reduction of the installation area of each display device 102. As described above, the housing 101 is downsized without downsizing the eyepieces 105, and therefore, realistic sensation is not reduced. Additionally, downsizing the display devices 102 achieves a reduction in weight, and therefore, a reduction in size and weight of the head-mounted display 1 is possible. That is, in the head-mounted display 1, a reduction in size and weight is achieved while the diameter of each eyepiece 105 is maintained.

Thus, since the diameter of each eyepiece 105 is maintained and the field of view is thus not narrowed, it is possible to realize the head-mounted display 1 whose size and weight is reduced without reducing realistic sensation.

Additionally, the distance from the location where each-infrared light source 104 is disposed to the outer periphery of the display device 102 is also reduced by a reduction of the installation area of each display device 102 provided to the housing 101. Thus, further downsizing of the housing 101 is possible by the reduction of the distance from the location where the infrared light source 104 is disposed to the outer periphery of the display device 102.

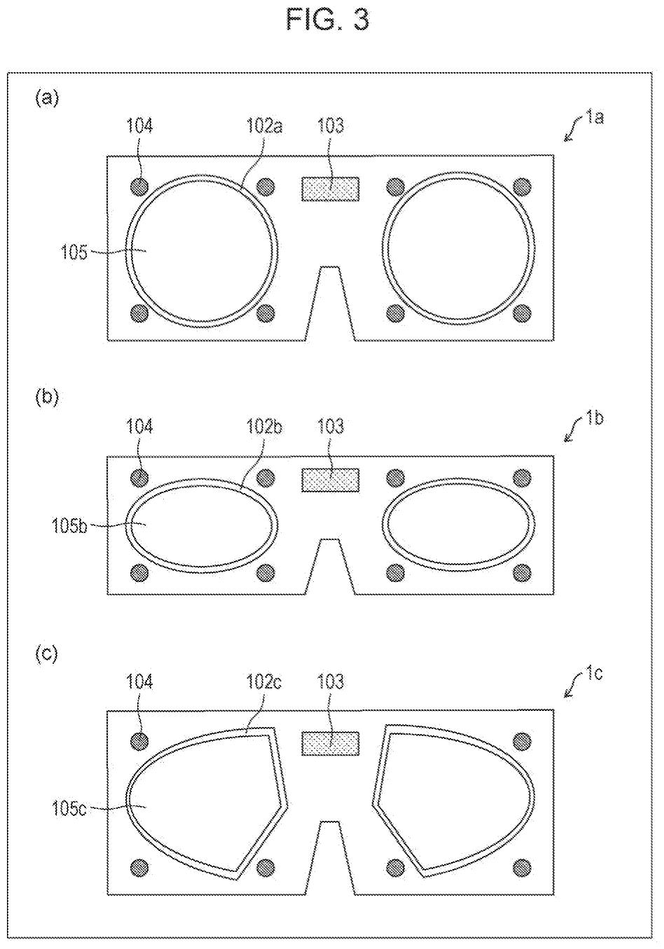

Note that in the present embodiment, an example in which the outer shape of each display device 102 of the head-mounted display 1 is octagonal has been described, but this should not be construed as limiting. It is required only that the outer shape of the display device 102 corresponds to the outer shape of the eyepiece 105. Moreover, an example in which the outer shape of each eyepiece 105 of the head-mounted display 1 is round has been described, but this should not be construed as limiting. That is, examples of the outer shape of the head-mounted display 1 may include other shapes as shown in FIG. 3.

<Variations>

FIG. 3 is a view schematically illustrating configurations of variations of the head-mounted display 1 shown in FIG. 1.

In an example shown in (a) of FIG. 3, a head-mounted display 1a is shown which includes round display devices 102a and round eyepieces 105a.

In an example shown in (b) of FIG. 3, a head-mounted display 1b is shown which includes elliptic display devices 102b and elliptic eyepieces 105b.

In an example shown in (c) of FIG. 3, a head-mounted display 1c is shown which includes display devices 102c and eyepieces 105c each having a round shape on an outer side and a rectangular shape on an inner side.

In each of the head-mounted displays 1a, 1b, and ac shown in FIG. 3, the outer shapes of the display devices 102a, 102b, and 102c also respectively corresponds to the outer shapes of the eyepieces 105a, 105b, and 105c as much as possible.

Thus, in the head-mounted display 1, a display region other than the projection region in which the eyepiece 105 is projected onto the display device 102 is a region which is not perceivable by a user. Therefore, as long as the outer shape of the display device 102 also corresponds to the outer shape of the eyepiece 105 as much as possible, the display devices 102 and the eyepiece 105 may have any shape.

Moreover, the infrared light sources 104 are provided in the vicinity of cut out portions of the display devices 102, but a light-receiving element (not shown) other than the infrared light sources 104 may be provided. That is, the light-receiving element disposed in a space effective for downsizing of the apparatus is used to determine whether or not the head-mounted display 1 is in a mounted state.

Note that in the present embodiment, an example in which an organic EL panel is used as each display device 102 has been described, but in a second embodiment below, an example in which a liquid display panel is used as each display device 102 will be described.

### Second Embodiment

Another embodiment of the present invention will be described below. Note that for the sake of description, members having the same functions as the members described in the embodiment are denoted by the same reference signs, and the description thereof will be omitted.

<Schema of Head-Mounted Display>

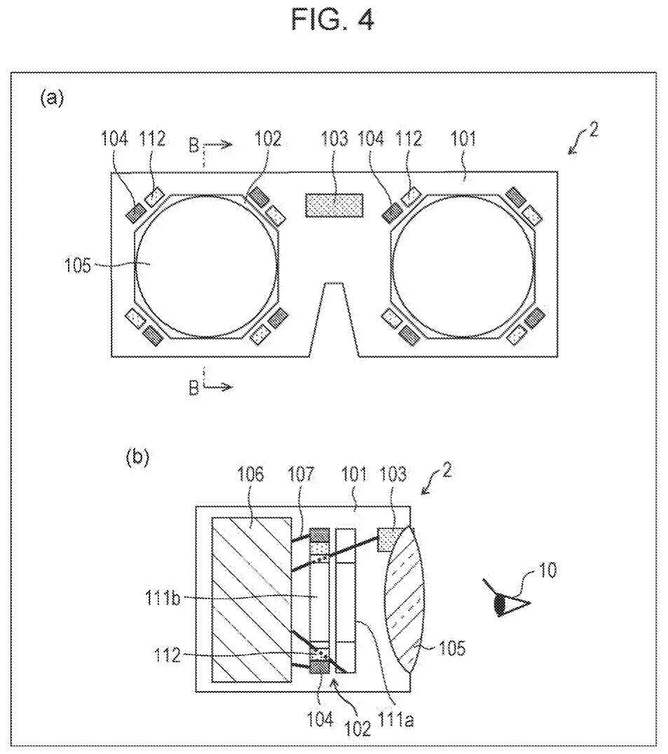

FIG. 4 is a view schematically illustrating a head-mounted display 2 according to the present embodiment.

As illustrated in FIG. 4, a head-mounted display 2 includes liquid crystal display panels in place of the organic EL panels used as the display devices 102 of the head mounted-display 1 in the first embodiment.

As illustrated in (b) of FIG. 4, each display devices 102 includes a liquid crystal display panel 111a and a backlight 111b with which a back surface of the liquid crystal display panel 102a is irradiated with light. As light source units of the backlight 111b, white light sources 112 for display are newly provided.

As illustrated in (a) of FIG. 4, each of the white light sources 112 is disposed adjacent to a corresponding one of infrared light sources 104 and is connected to a control unit 106 via a connection component 107.

<Effects>

The head-mounted display 2 having the above-described configuration is heavier than the head-mounted display 1 of the first embodiment adopting the organic EL panels as the display devices 102, but as in the case of the head-mounted display 1, each display device 102 has an outer shape corresponding to the outer shape of a corresponding one of the eyepieces 105. A display region of the display device 102 at least includes a projection region in which an eyepiece 105 is projected onto the display device 102, and the outer periphery of the display device 102 is in the proximity of the outer periphery of the projection region.

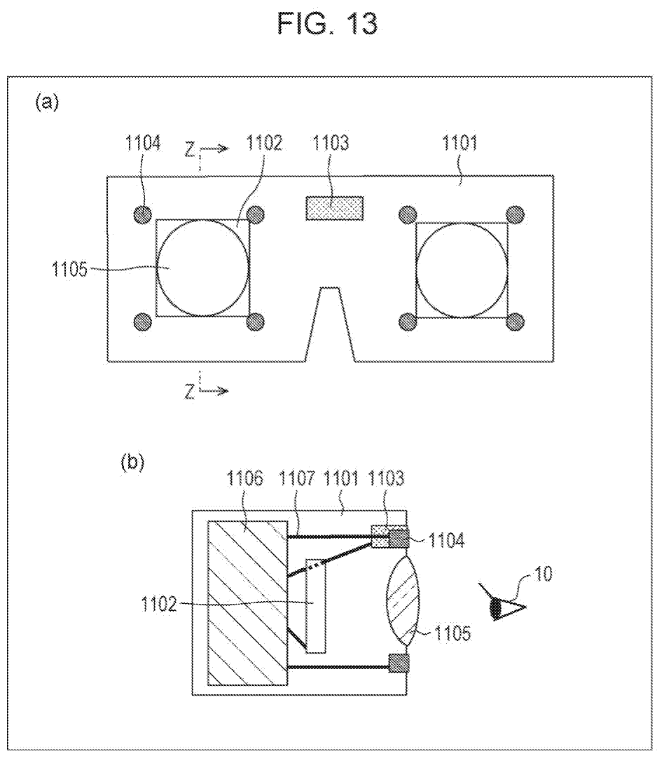

Thus, the head-mounted display of the present embodiment is heavier than that of the first embodiment but is reduced in size and weight as compared to the conventional head-mounted display shown in FIG. 11, and the eyepieces are not downsized as compared to those of the conventional head-mounted display shown in FIG. 13, and therefore, the field of view is not narrowed, and realistic sensation is not reduced. That is, also the head-mounted display 2 of the present embodiment provides the effect that the head-mounted display 1 which is reduced in size and weight without reducing the realistic sensation is realizable.

Also in the head-mounted displays 1 and 2 respectively of the first and second embodiments, determination of whether the head-mounted display is mounted or dismounted and eye tracking of a user are performed, but the detailed description thereof is omitted. In a third embodiment below, determination of whether the head-mounted display is mounted or dismounted and eye tracking of a user will be described, and an example in which the head-mounted display is reduced in size and weight will be described.

### Third Embodiment

Another embodiment of the present invention will be described below. Note that for the sake of description, members having the same functions as the members described in the embodiment are denoted by the same reference signs, and the description thereof will be omitted.

<Schema of Head-mounted Display>

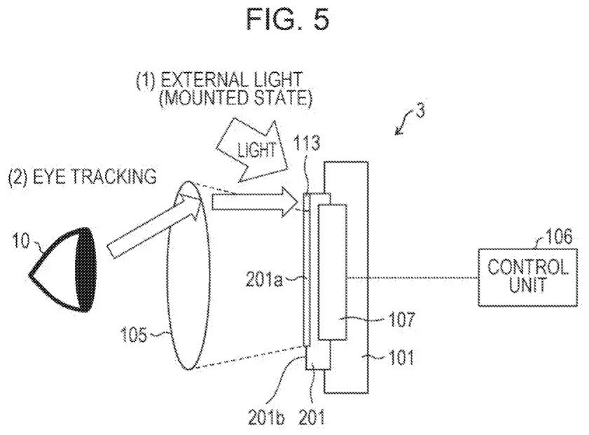

FIG. 5 is a view schematically illustrating a head-mounted display 3 according to the third embodiment of the present invention.

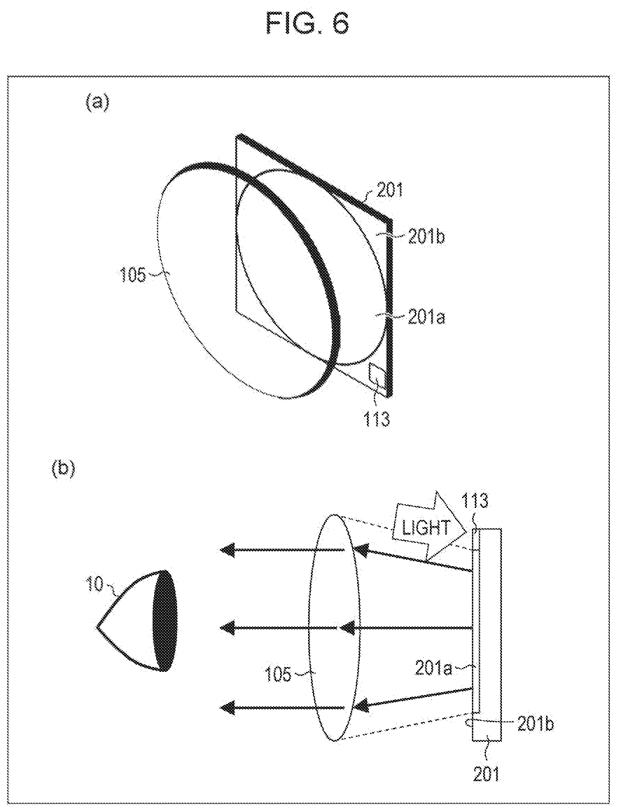

FIG. 6 is a detailed view illustrating the head-mounted display shown in FIG. 5.

As illustrated in FIG. 5, a head-mounted display 3 is different from the head-mounted display 1 of the first embodiment in that light-receiving elements 113 for determination of the mounted/dismounted state of the head-mounted display 3 and eye tracking are integrally provided with display devices 201.

Each display device 201 includes an ineffective display region (a region which is not perceivable by a user even when displaying is performed) in accordance with the shape of a corresponding one of eyepieces 105. This is described in the first embodiment. In general, when each display device 201 has a quadrangular outer shape and each eyepiece 105 has a round outer shape, four corners of each display device 201 are ineffective display regions 201b as illustrated in FIG. 6. The ineffective display regions 201b are provided with the light-receiving elements 113.

That is, in the head-mounted display 3 according to the present embodiment, unlike the head-mounted displays 1 and 2 respectively of the first and second embodiments, the outer shape of each display device 201 does not correspond to the outer shape of the corresponding one of the eyepieces 105, but the light-receiving elements 113 are disposed in the ineffective display regions 201b of each display device 201, and thereby, the ineffective display regions 201b which are not perceivable by a user are effectively used.

The light-receiving elements 113 are specifically formed as described below. When each display device 201 is a liquid crystal display panel, each of an effective display region 201a and the ineffective display regions 201b includes: a TFT including a source electrode and a gate electrode; and liquid crystal capacitance. The TFT of each ineffective display region 201b, the liquid crystal capacitance, and additionally, a diode (for example, PIN structure) are used to realize each light-receiving element 113. That is, when the diode included in the light-receiving element 113 is irradiated with light, the amount of a leakage current increases. A control unit 106 computes the amount of received light from the amount of leakage current which increases and which is measured by the light-receiving element 113.

<Effects>

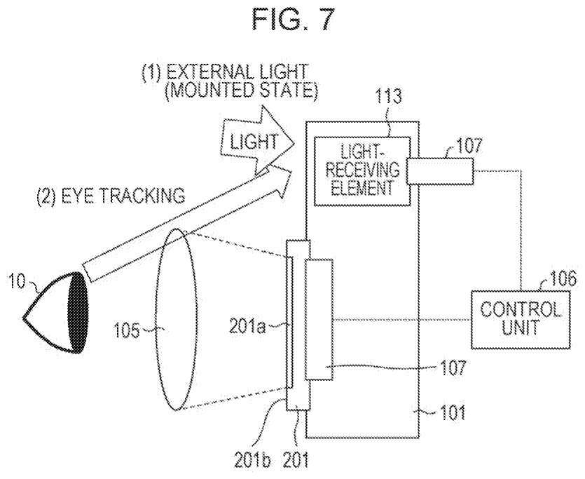

FIG. 7 is a view schematically illustrating a configuration of a comparative example of the head-mounted display shown in FIG. 5.

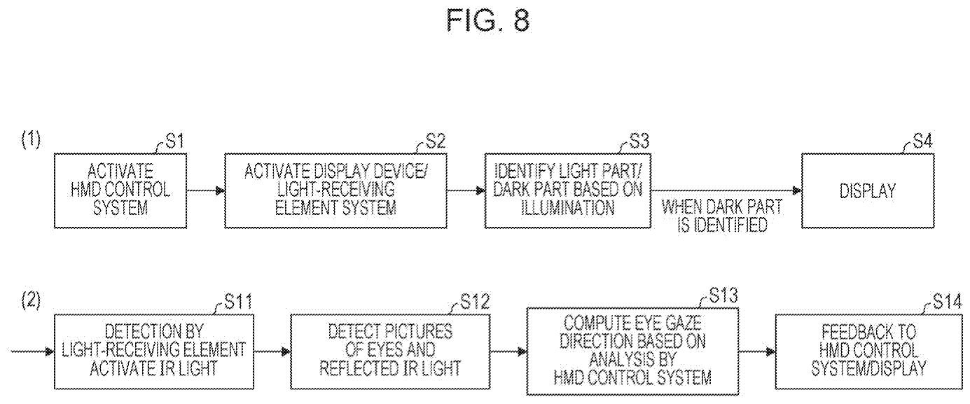

FIG. 8 is a view illustrating a flow of a process of illumination detection and eye tracking by the head-mounted display shown in FIG. 5.

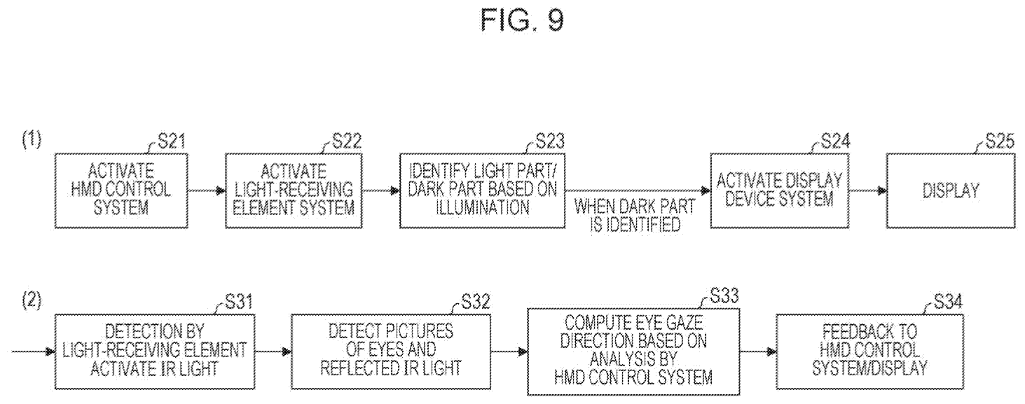

FIG. 9 is a view illustrating a flow of a process of illumination detection and eye tracking by a head-mounted display of a comparative example.

A head-mounted display of the comparative example shown in FIG. 7 is different from the head-mounted display 3 shown in FIG. 5 in that light-receiving elements 113 are separated from display devices 201 and are provided in a housing 101.

In this way, providing the light-receiving elements 113 separately from the display devices 201 increases the size of the housing 101, and consequently, the size of the head-mounted display also increases. Moreover, depending on locations where the light-receiving elements 113 are provided, a flow of a process of illumination detection and a process of eye tracking varies. Here, the illumination detection refers to detection of mounting/dismounting of the head-mounted display.

That is, as illustrated in FIG. 5, when the light-receiving elements 113 are provided integrally with the display devices 201, an HDM control system is first activated in the process of illumination (mounting/dismounting) detection as illustrated in (1) of FIG. 5 and (1) of FIG. 8 (step S1). Activation of the HDM control system means activation of the control unit 106 of the head-mounted display 3. That is, the HDM control system is a synonym for the control unit 106. Then, a display device/light-receiving element system is activated (step S2). Activation of the display device/light-receiving element system means activation of the display devices 201 integrally provided with the light-receiving elements 113. Note that in this embodiment, the light-receiving elements 113 are provided integrally with the display devices 201, and therefore, the activation of the display devices 201 also activates the light-receiving elements 113. Subsequently, based on illumination, a light part and a dark part are identified (step S3). Specifically, the light part and the dark part are identified based on the amount of light detected by the light-receiving elements 113. If the light part is identified, it is assumed that the head-mounted display 3 is dismounted, and if the dark part is identified, it is determined that a user wears the head-mounted display 3, and displaying on the display devices 201 is performed (step S4).

Moreover, as illustrated in (2) of FIG. 5 and (2) of FIG. 8, in the process of eye tracking, detection by the light-receiving elements 113 and activation of an IR light are performed first (step S11). Here, the IR light is, although not shown in FIG. 5, the same as the infrared light sources 104 in the first embodiment. Next, a picture of the eyes 10 of the user and the reflected IR light is detected (S12). Here, although not shown in FIG. 5, an infrared camera the same as the infrared camera 103 of the first embodiment performs imaging in a state where the eyes 10 of the user are irradiated with infrared radiation. Subsequently, an analysis by the HMD control system computes an eye gaze direction (step S13). Here, in the control unit 106, the picture detected in step S12 is analyzed by the control unit 106, and the eye gaze direction of the user is computed. Finally, feedback to the HDM control system/display is performed (step S14). Here, information (eye gaze-tracking information) regarding the eye gaze direction of the user is sent to the HDM system, and the control unit 106 in the HDM system generates an input image signal reflecting eye gaze-tracking results and transmits the input image signal to a controller to cause the display devices 201 to perform displaying.

In contrast, as illustrated in FIG. 7, when the light-receiving elements 113 are provided separately from the display devices 201, that is, when the light-receiving elements 113 are not provided integrally with the display devices 201 as illustrated in FIG. 5, an HDM control system is first activated in the process of illumination detection (mounting/dismounting) as illustrated in (1) of FIG. 7 and (1) of FIG. 9 (step S21). Then, the light-receiving element system is activated (step S22). Subsequently, based on illumination, a light part and a dark part are identified (step S23). If the dark part is identified, it is determined that a user wears the head-mounted display 3, and a display apparatus is activated (step S24). Then, displaying is performed (step S4).

Moreover, as illustrated in (2) of FIG. 7 and (2) of FIG. 9, in the process of eye tracking, detection by the light-receiving elements 113 and activation of an TR light are performed first (step S31). Next, a picture of the eyes and the reflected IR light is detected (step S32). Subsequently, an analysis by the HMD control system computes an eye gaze direction (step S33). Finally, feedback to the HDM control system/display is performed (step S44).

As described above, in the present embodiment, each light-receiving element 113 is integrated with a corresponding one of the display devices 201, and therefore, a reduction in size and weight of the head-mounted display 3 is possible. That is, as in the present embodiment, when the light-receiving elements 113 are provided by using circuits in the ineffective display regions 201b of the display devices 201, the weight of the light-receiving elements 113 themselves is, unlike a case of providing the light-receiving elements 113 separately from the display devices 201, not applied to the head-mounted display, and spaces in which the light-receiving elements 113 are to be provided do not have to be newly prepared. Therefore, it is possible to realize the head-mounted display 3 having reduced size and weight.

Additionally, the light-receiving elements 113 are provided integrally with the display devices 201, and thereby, it is possible to further reduce the distance between each of the eyes 10 and a corresponding one of locations where the light-receiving elements 113 are provided. Therefore, the light-receiving elements 113 are disposed substantially in front of the eyes (via the eyepieces 105) when eye tracking is performed. Thus, detection accuracy of and sensitivity to the eye gaze when the eye tracking is performed is improved.

Moreover, in the present embodiment, an example in which the light-receiving elements 113 are provided in the ineffective display regions 201b of each display device 201 has been described, but, for example, the ineffective display regions 201b may be provided with infrared light sources.

Note that in the present embodiment, an example has been described in which although each light-receiving element 113 is formed integrally with a corresponding one of the display devices 201, the light-receiving elements 113 are formed not in the effective display region 201a but in the ineffective display regions 201b at corners of each display device 201. However, in a fourth embodiment below, an example including a display device including an optical sensor (a light-receiving element) will be described, the light-receiving element being formed in the display region of the display device.

### Fourth Embodiment

Another embodiment of the present invention will be described below. Note that for the sake of description, members having the same functions as the members described in the embodiment are denoted by the same reference signs, and the description thereof will be omitted.

<Schema of Head-Mounted Display 4>

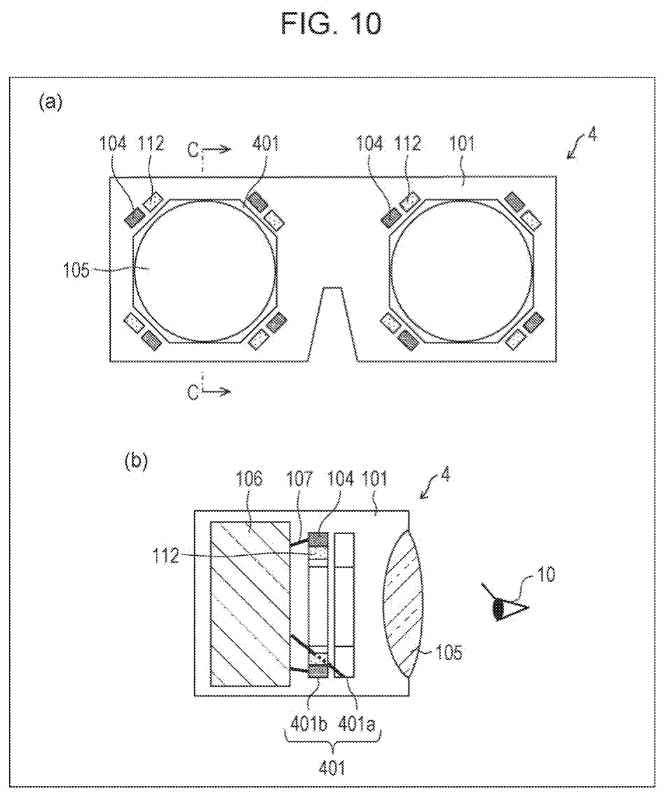

FIG. 10 is a view schematically illustrating a configuration of a head-mounted display 4 according to the present embodiment.

As illustrated in FIG. 10, the head-mounted display 4 includes optical sensor-equipped display devices 401 including a light-receiving element, (an optical sensor) in a display region in place of the display devices 102 of the head-mounted display 2 of the second embodiment.

As illustrated in (b) of FIG. 10, the optical sensor-equipped display devices 401 each include a liquid crystal display panel 401a and a backlight 401b with which a back surface of the liquid crystal display panel 401a is irradiated with light. As light source units of the backlight 401b, white light sources 112 for display are provided.

Each optical sensor-equipped display device 401 basically has the same configuration as the display device 102 of the head-mounted display 2 of the second embodiment but is different in that a light-receiving element (optical sensor) is built in the liquid crystal display panel 401a. Moreover, the configuration of the optical sensor-equipped display device 401 is different from the configuration of the third embodiment, that is, the configuration in which the light-receiving element 113 is formed integrally with the display device 201. That is, the optical sensor-equipped display device 401 is different in that the light-receiving element is provided not in the ineffective display region but in the display region of the liquid crystal display panel 401a.

<Effects>

The head-mounted display 4 having the above-described configuration includes the optical sensor-equipped display devices 401, and therefore, optical sensors (light-receiving elements) do not have to be provided in addition to the display devices and do not have to be provided in the ineffective display regions of the display device. Therefore, similarly to the first embodiment, it is possible to form the outer shape of the optical sensor-equipped display device 401 so as to correspond to the outer shape of the eyepiece 105. In the present embodiment, as shown in (a) of FIG. 10, the outer shape of each optical sensor-equipped display device 401 has an octagonal shape as in the case of the display device 102 of the head-mounted display 1 of the first embodiment. That is, each optical sensor-equipped display device 401 has a shape corresponding to an outer shape of a corresponding one ox the eyepieces 105. The outer shape of the eyepiece 105 corresponds to a shape formed when the eyepiece 105 is projected onto the optical sensor-equipped display devices 401. The optical sensor-equipped display devices 401 each has a variant shape (octagonal shape) and has to a narrow frame. Thus, each optical sensor-equipped display devices 401 having a variant shape and having a narrow frame may be realized, for example, by distributing terminal units for receiving signals at a plurality of locations or by distributing peripheral circuits (gate drivers) in the display region.

In the head-mounted display 4 having the above-described configuration, the outer shape of the optical sensor-equipped display device 401 corresponds, similarly to the head-mounted display 1 of the first embodiment, to the outer shape of the display device 105. The display region of the optical sensor-equipped display device 401 at least includes a projection region in which the eyepiece 105 is projected onto the optical sensor-equipped display device 401, and the outer periphery of the optical sensor-equipped display device 401 is in the proximity of the outer periphery of the projection region.

This enables only the installation area of each optical sensor-equipped display device 401 provided to the housing 101 to be reduced without changing the size of each eyepiece 105. Therefore, it is possible to downsize the housing 101 by a reduction of the installation area of each optical sensor-equipped display device 401. As described above, the housing 101 is downsized without downsizing the eyepieces 105, and therefore, realistic sensation is not reduced. Additionally, downsizing the optical sensor-equipped display devices 401 achieves a reduction in weight, and therefore, a reduction in size and weight of the head-mounted display 1 is possible. That is, in the head-mounted display 1, a reduction in size and weight is achieved while the diameter of each eyepiece 105 is maintained.

Thus, since the diameter of each eyepiece 105 is maintained and the field of view is thus not narrowed, it is possible to realize the head-mounted display 1 whose size and weight is reduced without reducing realistic sensation.

Additionally, the distance from the location where each infrared light source 104 is disposed to the outer periphery of the display device 102 is also reduced by a reduction of the installation area of each optical sensor-equipped display device 401 provided to the housing 101. Thus, further downsizing of the housing 101 is possible by the reduction of the distance from the location where the infrared light source 104 is disposed to the outer periphery of the display device 102.

Moreover, according to the optical sensor-equipped display device 401, similarly to the head-mounted display 3 of the third embodiment, it is possible to reduce the distance between each of the eyes 10 and a corresponding one of locations where the light-receiving elements (not shown) of each optical sensor-equipped display device 401 is disposed. Therefore, the light-receiving elements are disposed substantially in front of the eyes (via the eyepieces 105) when eye tracking is performed, and thus, an effect is provided that detection accuracy of and sensitivity to the eye gaze when the eye tracking is performed is improved.

### Summary

A head-mounted display according to a first aspect of the invention is a head-mounted display 1, 2, or 4 including: a housing 101; display sections (display devices 102) in each of which an image is to be displayed; and eyepieces 105 with which a user views the display sections (the display devices 102), the display sections and the eyepieces being provided to the housing 101, wherein each of the display sections (display device 102) includes a display region in which an area of the image viewed by the user through a corresponding one of the eyepieces 105 is an effective display region and an area other than the area of the image viewed by the user is an ineffective display region, and each of the display sections (the display devices 102) has a shape in which the ineffective display region is cut out from the display region.

With this configuration, each display section has a shape in which the ineffective display region is cut out from the display region. For example, when each display section has a quadrangular shape, each eyepiece has a round shape, and a projected image obtained by projecting the eyepiece onto the display section is smaller than the display region of the display section, an area viewable when a user views the display section through the eyepiece is an area of the projected image (round shape) of the eyepiece projected. Thus, the display region located outside the projected image of the eyepiece projected is an ineffective display region which is not perceivable by a user. The display section from which the ineffective display region is cut out has an outer shape corresponding to the outer diameter of the eyepiece.

Thus, a reduction in size and weight of the head-mounted display is possible by cutting out the ineffective display region.

Besides, while the diameter of the eyepiece is maintained, only the display section is downsized, and therefore, the sight is not narrowed. Therefore, a problem does not occur that reducing the diameter of the eyepiece to downsize the head-mounted display reduces the realistic sensation.

Thus, while the diameter of each eyepiece is maintained, a head-mounted display with reduced size and weight is realizable.

A head-mounted display according to a second aspect of the invention referring to the first aspect may further include infrared light sources 104 which are disposed in a vicinity of cut out parts of the display sections (display devices 102) and which are configured to emit infrared light to the eyes of the user.

With this configuration, the infrared light sources are provided in the vicinity of the cut out parts of the display sections, which enables the housing to be downsized by providing the infrared light sources in the vicinity of the display sections, and as a result, a further reduction in size and weight of the head-mounted display is possible. Additionally, disposing the infrared light sources in the vicinity of the display sections results in the infrared light sources disposed in front of the eyes of a user, and thus, it becomes possible to securely emit infrared light to the eyes of the user,

A head-mounted display according to a third aspect of the invention referring to the first or second aspect may further include light-receiving elements disposed in a vicinity of cut out portions of the display sections.

With this configuration, disposing the light-receiving elements in the vicinity of the cut out portions of the display sections results in disposition of the light-receiving elements in front of the eyes of the user, and therefore, it is possible to securely receive the infrared light reflected off the eyes of the user. Thus, luminance, display quality, and the like are controlled according to the eye gaze of the user to optimize the display.

In a head-mounted display according to a fourth aspect of the invention referring to any one of the first to third aspects, each of the display sections is an optical sensor-equipped display device 401 provided with a light-receiving element formed in the effective display region.

With this configuration, each of the display sections is an optical sensor-equipped display device provided with a light-receiving element formed in the effective display region, and therefore, a light-receiving element does not have to be provided additionally to the display device and does not have to be provided in the ineffective display region of the display device. Thus, it is possible to form the outer shape of the optical sensor-equipped display device to correspond to the outer shape of the eyepiece.

A head-mounted display according to a fifth aspect of the invention referring to any one of the first to fourth aspects, each of the display sections (the display devices 102) has an outer shape identical with an outer shape of a corresponding one of the eyepieces 105.

With this configuration, each of the display section (each of the display devices 102) has an outer shape identical with an outer shape of a corresponding one of the eyepieces 105. Thus, it is possible to eliminate the ineffective display region of each display section, and a further reduction in size and weight of each display section is possible.

A head-mounted display according to a sixth aspect of the invention is a head-mounted display 3 includes: a housing 101; display sections (display devices 201) in each of which an image is to be displayed; and eyepieces 105 with which a user views the display sections (the display devices 201), the display sections and the eyepieces being provided to the housing 101, wherein each of the display sections (display device 201) includes a display region in which an area of the image viewed by the user through a corresponding one of the eyepieces 105 is an effective display region 201a and an area other than the area of the image viewed by the user is an ineffective display region 201b, and in the ineffective display region 201b, a light-receiving element 113 is disposed.

With this configuration, the light-receiving element is disposed in the ineffective display region of the display section, and thereby, the ineffective display region which is not perceivable by a user is effectively used.

Additionally, disposing the light-receiving element in the ineffective display region of the display section results in disposition of the light-receiving elements in front of the eyes of the user, and therefore, it is possible to securely receive the infrared light reflected off the eyes of the user. Thus, luminance, display quality, and the like are controlled according to the eye gaze of the user to optimize the display.

A head-mounted display according to a seventh aspect of the invention referring to the sixth aspect further includes an infrared light source provided in the ineffective display region 201b.

With this configuration, the infrared light source is provided in the ineffective display region, which enables the housing to be downsized by providing the infrared light sources in the vicinity of the display sections, and as a result, a further reduction in size and weight of the head-mounted display is possible. Additionally, disposing the infrared light sources in the vicinity of the display sections results in the infrared light sources disposed in front of the eyes of a user, and thus, it becomes possible to securely emit infrared light to the eyes of the user.

The present invention is not limited to the embodiments described above, and various modifications may be made within the scope of the claims. The present disclosure also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 to 4 HEAD-MOUNTED DISPLAY

101 HOUSING

102 DISPLAY DEVICE (DISPLAY SECTION)

102a, 102b, 102c DISPLAY DEVICE (DISPLAY SECTION)

103 INFRARED CAMERA

104 INFRARED LIGHT SOURCE

105 EYEPIECE

105a, 105h, 105c EYEPIECE

106 CONTROL UNIT

107 CONNECTION COMPONENT

108 MAIN CONTROL UNIT

109 EYE GAZE-TRACKING UNIT

110 DISPLAY SECTION CONTROLLER

111a LIQUID CRYSTAL DISPLAY PANEL

111b BACKLIGHT

112 WHITE LIGHT SOURCE

113 LIGHT-RECEIVING ELEMENT

201 DISPLAY DEVICE (DISPLAY SECTION)

201a EFFECTIVE DISPLAY REGION

201b INEFFECTIVE DISPLAY REGION

401 OPTICAL SENSOR-EQUIPPED DISPLAY DEVICE (DISPLAY SECTION)

401a LIQUID CRYSTAL DISPLAY PANEL

401b BACKLIGHT

1. A head-mounted display including:
a housing;
display sections in each of which an image is to be displayed; and
eyepieces with which a user views the display sections,
the display sections and the eyepieces being provided to the housing, wherein
each of the display sections includes a display region in which an area of the image viewed by the user through a corresponding one of the eyepieces is an effective display region and an area other than the area of the image viewed by the user is an ineffective display region, and
each of the display sections has a shape in which the ineffective display region is cut out.

2. The head-mounted display according to claim 1, further comprising:
infrared light sources which are disposed in a vicinity of cut out parts of the display sections and which are configured to emit infrared light to the eyes of the user.

3. The head-mounted display according to claim 1, further comprising: light-receiving elements disposed in a vicinity of cut out portions of the display sections.

4. The head-mounted display according to claim 1, wherein
each of the display sections is an optical sensor-equipped display device provided with a light-receiving clement formed in the effective display region.

5. The head-mounted display according claim 1, wherein
each of the display sections has an outer shape identical with an outer shape of a corresponding one of the eyepieces.

6. A head-mounted display comprising:
a housing;
display sections in each of which an image is to be displayed; and
eyepieces with which a user views the display sections,
the display sections and the eyepieces being provided to the housing, wherein
each of the display sections includes a display region in which an area of the image viewed by the user through a corresponding one of the eyepieces is an effective display region and an area other than the area of the image viewed by the user is an ineffective display region, and
in the ineffective display region, a light-receiving clement is disposed.

7. The head-mounted display according to claim 6, further comprising:
an infrared light source provided in the ineffective display region.
